(19) United States
(12) Patent Application Publication
(10) Pub. No.: US 2026/0247030 A1
(43) Pub. Date: Aug. 20, 2026

(54) COMMUNICATION PLATFORM FOR A STANDALONE DIGITAL CAMERA

(71) Applicant: T-Mobile USA, Inc., Bellevue, WA (US)

(72) Inventors: Anbalagan Elumalai, Issaquah, WA (US); Saravanan Elumalai, Bothell, WA (US); Sudhanshu Pandey, Sammamish, WA (US)

(21) Appl. No.: 19/058,659

(22) Filed: Feb. 20, 2025

(51) Int. Cl. H04N 23/661; H04N 23/617

(52) U.S. Cl. CPC H04N 23/661; H04N 23/617

(57) ABSTRACT

Techniques and systems are disclosed that relate to a domain name system (DNS), dynamic host configuration protocol (DHCP), and IP address management (IPAM) (DDI) platform for a standalone digital camera. A standalone digital camera, which includes an international mobile subscriber identity (IMSI) within an embedded subscriber identity module (eSIM), is registered with a IoT service enabler. This registration enables subsequent communications between the IoT service enabler and the standalone digital camera in association with the IMSI. After registration, the IoT service enabler transmits a first communication to the standalone digital camera over the wireless network, signaling the camera to perform an action. The standalone digital camera sends a second communication containing data from the camera back to the IoT service enabler. Upon receiving this second communication, the IoT service enabler stores the data, facilitating efficient management and analysis of the camera's operation.

### BACKGROUND

Standalone digital cameras, while offering superior image quality and advanced features compared to smartphone cameras, present several challenges. For one, these devices pose a substantial threat risk due to their cost and universal applicability. Standalone digital cameras also, in general, lack cellular connectivity, meaning that they can only connect to wireless services through Wi-Fi or Bluetooth. Standalone digital cameras often have limited storage capacity, requiring users to frequently manage and transfer files to avoid running out of space. The nature of this type of wireless connectivity, however, is spatially limited to small coverage areas. Connectivity issues with Wi-Fi and Bluetooth can hinder the seamless transfer of images and remote-control functionalities, leading to frustration and inefficiency. Performing firmware updates on these devices can also be cumbersome, as it typically involves downloading updates to a computer and then transferring them to the camera, a process that is not always user-friendly.

### BRIEF DESCRIPTION OF THE DRAWINGS

Detailed descriptions of implementations of the present invention will be described and explained through the use of the accompanying drawings.

FIG. 1 illustrates a wireless communications system that can implement aspects of the present technology.

FIG. 2 illustrates 5G core NFs that can implement aspects of the present technology.

FIG. 3 illustrates an example standalone digital camera in which aspects of the present technology can be implemented.

FIG. 4 illustrates an IoT service enabler in which aspects of the present technology can be implemented.

FIG. 5 illustrates an example architecture for communication between a standalone digital camera and an IoT service enabler in accordance with aspects of the present technology.

FIG. 6 illustrates an example method for communication between a standalone digital camera and an IoT service enabler in accordance with aspects of the present technology.

FIG. 7 is a block diagram that illustrates an example of a computing system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology relates to standalone digital cameras. A standalone digital camera is a dedicated device designed specifically for capturing high-quality photographs and videos. Unlike smartphone cameras, standalone digital cameras have functionality that enables or assists in imaging, editing, and image storage. For example, standalone digital cameras generally lack wireless connectivity beyond simple Wi-Fi or Bluetooth accessibility. Thus, these devices generally must be within limited Wi-Fi or Bluetooth coverage areas to upload/download to/from the Internet. Alternatively, uploads or downloads can be made to/from a computer to which the standalone digital camera is connected (e.g., through a hard-wired connection) to facilitate communication for the standalone digital camera. Even when provided this limited wireless access, many standalone digital cameras are limited to dedicated access to specific applications, rather than general access to the Internet through a browser. For example, a standalone digital camera may be limited in access to a cloud server at which images can be stored and a server through which firmware/software can be downloaded.

With the increase in smartphone usage, many users turn to integrated cameras within their smartphones to capture a picture or record a memory. Despite the added convenience of a single integrated device capable of call, text, web browsing, and camera functionality, standalone digital cameras remain prevalent in various fields due to their superior image quality, versatility, and advanced features. For example, standalone digital cameras are indispensable in professional photography, where high resolution, interchangeable lenses, and manual controls are crucial. They are widely used in fields such as journalism, wildlife photography, sports, and event coverage, where capturing fast-moving subjects and achieving precise focus are essential. Additionally, these cameras are favored by hobbyists and enthusiasts who appreciate the creative control and image quality that standalone digital cameras offer. In the realm of videography, many standalone digital cameras provide high-definition and 4K video recording capabilities, making them valuable tools for filmmakers and content creators.

While standalone digital cameras provide certain benefits over other types of cameras, such as smartphone cameras, they also have their limitations. For example, standalone digital cameras may be limited to Wi-Fi or Bluetooth for providing wireless connectivity. Due to their limited coverage and unstable connections, devices deploying these technologies can intermittently lose connectivity. In the case of a standalone digital camera, which may utilize wireless connectivity to backup or store images captured by the device install updates, this loss of connectivity can result in corruptions or incomplete storage of images. Moreover, when connectivity is not available, images may be stored at the local storage, which can fill quickly and prevent future images from being collected without deleting currently stored images. This can be even more of a challenge for video applications, such as GoPro®, which capture large amounts of data and have limited storage. In these cases, wireless connectivity may be needed to effectively store data real time. Moreover, if connection is lost while a firmware/software package is being downloaded, the firmware/software may be installed with bugs or other issues. Standalone digital cameras also present a large theft risk, due to their high cost and general usability. Current theft prevention techniques are largely limited to routine techniques with limited effectiveness and flexibility, such as locking the camera in a locked storage space. Accordingly, additional techniques are needed to address the challenges presented by standalone digital cameras.

To address these problem and others, the present technology provides cellular functionality to standalone digital cameras provisioned with embedded subscriber identity module (eSIM). For example, a standalone digital camera can be implemented with an embedded universal integrated circuit card (eUICC) to which an eSIM can be provisioned for accessing a cellular network. Once provisioned, the eSIM can be used to communicate with the standalone digital camera. For example, the standalone digital camera can upload images or other data using the cellular network. Similarly, firmware or software packages can be received over the cellular network.

The present technology also provides for an IoT service enabler for managing one or more standalone digital cameras. The IoT service enabler can function as a domain name system (DNS), dynamic host configuration protocol (DHCP), and IP address management (IPAM) (DDI) platform. The IoT service enabler can serve as a comprehensive solution for managing, integrating, and analyzing data from a wide array of connected devices. The primary functionality of an IoT service enabler includes data collection, where it aggregates data from various standalone digital cameras or other wireless devices (e.g., Internet-of-Things devices). The IoT service enabler can communicate seamless communication across different devices and using different protocols (e.g., a constrained application protocol (CoAP), a message query telemetry transport (MQTT) protocol, a hypertext transfer protocol (HTTP), a lightweight machine-to-machine (LWM2M) protocol, and so on). The platform also provides robust data processing capabilities, enabling the transformation, filtering, and enrichment of raw data to generate meaningful insights. Analytics tools within the IoT service enabler allow for real-time monitoring, predictive analytics, and anomaly detection, helping administrators (e.g., users or device managers) make informed decisions and optimize operations. Additionally, the platform offers secure data storage and management, ensuring data integrity. With built-in scalability, the IoT service enabler can handle the growing volume of data as more devices are added to the network by registering the additional devices with the platform. The IoT service enabler can also interface with various application programming interfaces to provide indications of the data and analytics to applications accessible to the users of the managed standalone digital cameras. Similarly, the IoT service enabler can receive commands from the users of the managed standalone digital cameras through the APIs to cause the IoT service enabler to communicate with the standalone digital cameras using the cellular network to control operations of the standalone digital cameras.

The IoT service enabler can provide various functionality to the standalone digital camera ecosystem and control various aspects of a standalone digital camera. For example, the IoT service enabler can receive images from the standalone digital camera and store the images within the IoT service enabler server or on a cloud server accessible through the APIs available to the IoT service enabler. In this way, the IoT service enabler can provide secure cloud storage for the standalone digital camera.

The IoT service enabler can receive other data that can be used to determine appropriate control operations for the camera. For example, the camera can communicate location data to the IoT service enabler, and the IoT service enabler can analyze the location data to determine if the camera has been stolen. If the camera is determined to have been stolen, one or more functionalities of the camera can be disabled remotely by the IoT service enabler. In some cases, this disable operation can be issued after a user of the camera approves disabling the camera.

The IoT service enabler can also communicate with the camera over the cellular network to install firmware or software updates of the camera over the air (OTA). The IoT service enabler can track the current version of the firmware/software installed on the camera and, when a new version is released, install the new version on the camera. This installation can take place through the cellular network, thereby obviating the need for Wi-Fi, Bluetooth, or a physical connection with a more Internet-capable device, such as a computer.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

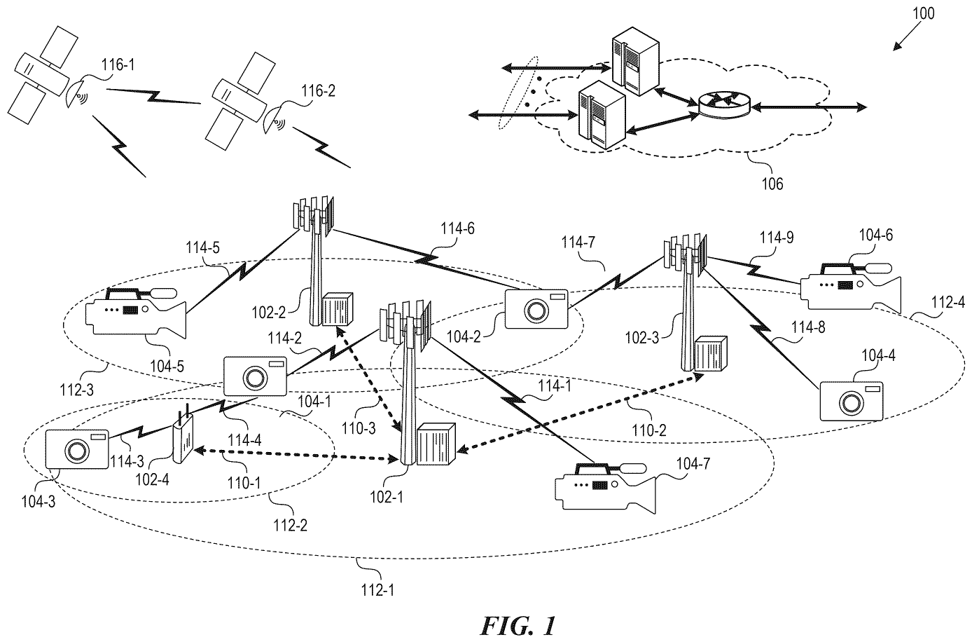

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 gigahertz (GHz) or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, IP connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., IoT, mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or packet data convergence protocol (PDCP) layer can be IP-based. A radio link control (RLC) layer then performs packet segmentation and reassembly to communicate over logical channels. A medium access control (MAC) layer can perform priority handling and multiplexing of logical channels into transport channels. The MAC layer can also use hybrid automatic repeat request (HARQ) to provide retransmission at the MAC layer to improve link efficiency. In the control plane, the radio resource control (RRC) protocol layer provides establishment, configuration, and maintenance of an RRC connection between a wireless device 104 and the base stations 102 or core network 106 supporting radio bearers for the user plane data. At the physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices and (e.g., smartphones, portable hotspots, tablets, etc.); laptops; wearables; drones; vehicles with wireless connectivity; head-mounted displays with wireless augmented reality/virtual reality (AR/VR) connectivity; portable gaming consoles; wireless routers, gateways, modems, and other fixed-wireless access devices; wirelessly connected sensors that provide data to a remote server over a network; IoT devices such as wirelessly connected smart home appliances; etc. As illustrated, the wireless devices 104 (e.g., wireless device 104-1, wireless device 104-2, wireless device 104-3, wireless device 104-4, wireless device 104-5, wireless device 104-6, and wireless device 104-7) include standalone digital cameras, including commercial and recreational photo and video cameras.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of the network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The DL transmissions can also be called forward link transmissions while the UL transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a non-terrestrial network (NTN) is enabled by one or more satellites, such as satellites 116-1 and 116-2, to deliver services anywhere and anytime and provide coverage in areas that are unreachable by any conventional terrestrial network (TN). A 6G implementation of the network 100 can support terahertz (THz) communications. This can support wireless applications that demand ultra-high quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged radio access network (RAN) and core architecture to achieve control and user plane separation (CUPS) and achieve extremely low user plane latency. In yet another example of 6G, the network 100 can implement a converged Wi-Fi and core architecture to increase and improve indoor coverage.

### 5G Core NFs

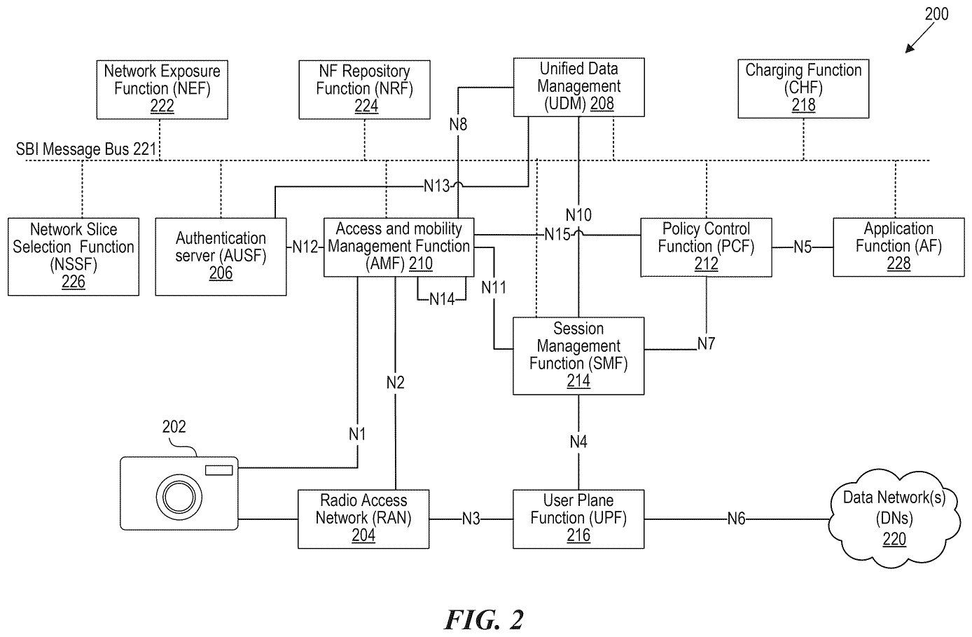

FIG. 2 illustrates 5G core NFs 200 that can implement aspects of the present technology. A wireless device 202 can access the 5G network through a NAN (e.g., gNB) of a RAN 204. The NFs include an authentication server function (AUSF) 206, a unified data management (UDM) 208, an access and mobility management function (AMF) 210, a policy control function (PCF) 212, a session management function (SMF) 214, a user plane function (UPF) 216, and a charging function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a service-based architecture (SBA) through a service-based interface (SBI) 221 that uses HTTP/2. The SBA can include a network exposure function (NEF) 222, an NF repository function (NRF) 224, a network slice selection function (NSSF) 226, and other functions such as a service communication proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, and service-level agreements and includes the virtualized resources required to service the needs of a mobile virtual network operator (MVNO) or group of subscribers, including a dedicated UPF, SMF, and PCF. The wireless device 202 is associated with one or more network slices, which all use the same AMF. A single network slice selection assistance information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a user data convergence (UDC) that separates a user data repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a home subscriber server (HSS) and can provide authentication credentials while being employed by the AMF 210 and SMF 214 to retrieve subscriber data and context.

The PCF 212 can connect with one or more application functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Example IoT Device

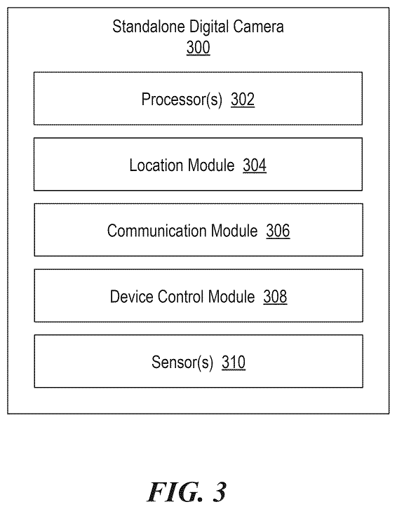

FIG. 3 illustrates an example standalone digital camera 300 in which aspects of the present technology can be implemented. The camera 300 includes at least one processor 302. The processor 302 can execute machine-readable instructions to manage and execute all computational tasks performed by the camera 300. For example, the various modules of the camera 300 can include machine-readable instructions executed by the processor 302. The processor 302 can be located at the camera 300 or remotely coupled with the camera 300. In aspects, the processor 302 can be a central processor or an application-specific processor.

The camera 300 includes a location module 304 responsible for providing location estimates of the camera 300. The location module 304 can include machine-readable instructions executable by the processor 302. The location module 304 can determine the location of the camera 300 using any appropriate mechanism. For example, the location module 304 can implement a global navigation satellite system (GNSS) to determine device location through signals received from one or more satellites. In some implementations, the location module 304 can determine its location through triangulation from proximate devices (e.g., base stations or other wireless devices). The location module 304 can continually track the location of the camera 300 or determine the location of the camera 300 at different times (e.g., at predetermined intervals or in response to collecting data that is to be reported with a location estimate). The location module 304 can determine the latitude, longitude, or elevation of the camera 300. The location module 304 can similarly determine the speed of the camera 300 based on differences in location estimates determined by the location module 304. Moreover, the location module 304 can determine a timestamp that corresponds with the location estimate. In this way, the location module 304 can ensure that the location information is accurate and up to date.

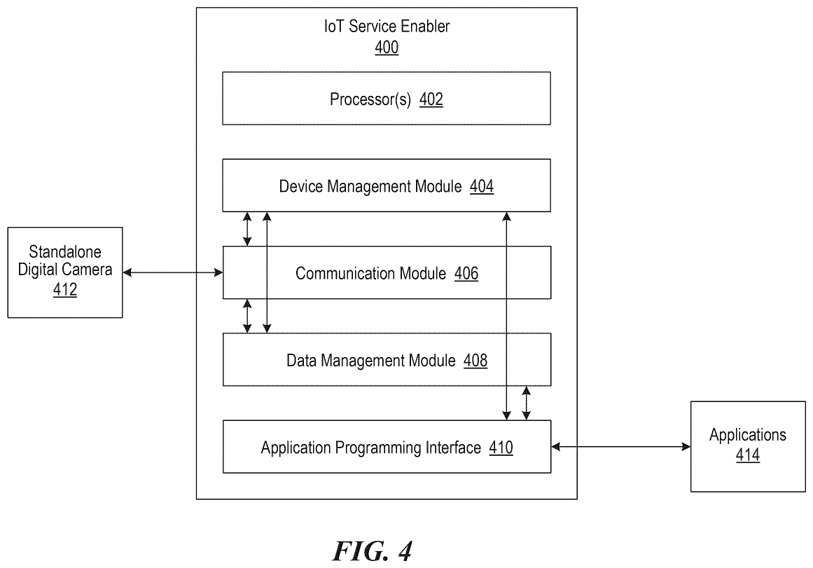

The camera 300 includes a communication module 306 implemented through machine-readable instructions executable by the processor 302. The communication module 306 can be used to communicate with an IoT service enabler (discussed with greater detail with respect to FIG. 4). In aspects, the camera 300 can include an eUICC that can be used to access a wireless telecommunications network with an authorized eSIM profile. Given that the eUICC is embedded on the camera 300, the eSIM can be provisioned to the camera 300 over the air (e.g., by the IoT service enabler). For example, the eUICC can include a bootstrapping profile that can be used to retrieve the eSIM over the air. The eSIM can include an international mobile subscriber identity (IMSI) that is authorized to access the network. Once provisioned to the camera 300, the camera 300 can have access to the wireless telecommunications network for subsequent communications. These communications can take place in association with the IMSI (e.g., after the IMSI is used to authenticate the camera 300).

The communication module 306 can communicate data collected by the camera 300 to an owner or manager of the camera 300—for example, the camera 300 can report collected data or operational data to the owner or manager of the camera 300 (e.g., through the IoT service enabler) using a wireless communication network. Moreover, the camera 300 can upload images collected by the camera 300 using the communication module 306. The communication module 306 can also be used to receive commands from the IoT service enabler that manages the camera 300. In aspects, the communication module 306 can communicate using any wireless communication technology. For example, the communication module 306 can communicate using either an IP data bearer or a non-IP data bearer (e.g., non-IP data delivery (NIDD)). The communication module 306 can maintain multiple data bearers (e.g., having different access point names (APNs)). Given this flexibility and the ability to communicate on a wireless telecommunication network, generally, the camera 300 can maintain wireless connectivity even in areas where no Wi-Fi or hard-wire signal is available. Connectivity can similarly be maintained in areas where network conditions (e.g., limited network coverage or high network congestion) make it difficult to maintain an IP-based connection. In this way, service disruptions at the camera 300 can be limited.

The communication module 306 can communicate using any communication protocol. In aspects, the communication module 306 can communicate using CoAP, such as the LwM2M protocol, which provides a structured protocol for managing multiple IoT devices and their connectivity. For example, the LwM2M protocol can organize device data into a hierarchical structure of objects, instances, and resources. Each resource can represent a specific piece of data or functionality, such as sensor readings or control commands. The communication module 306 can use this structure to manage and exchange data efficiently. For example, the communication module 306 can periodically send data to the platform, such as sensor readings, status updates, or alerts. The communication module 306 can further provide encryption, authentication, and integrity protection for the data exchanged, safeguarding it from unauthorized access and tampering. The communication module can similarly communicate using an MQTT protocol or HTTP.

The communication module 306 can issue registration requests to the IoT service enabler to register the camera 300 with the server and enable the camera 300 to communicate with and be managed by the IoT service enabler. To register with the IoT service enabler, the communication module 306 can communicate a registration request to the IoT service enabler. The registration request can include the endpoint name, supported LwM2M objects, or registration lifetime of the camera 300. The registration request can indicate (e.g., expressly or through the communication occurring over the active data bearer) that communications between the camera 300 and the IoT service enabler are to take place over the active data bearer.

The IoT service enabler can receive the registration request and register the camera 300 to enable communication with and monitoring of the camera 300. The registration can indicate that the camera 300 is registered with the IoT service enabler using the active data bearer (e.g., IP or non-IP) such that communication between the camera 300 and the IoT service enabler occurs using the active data bearer. The IoT service enabler can further store other information (e.g., images, location information, settings information, and so on) related to the camera 300 (e.g., in LwM2M objects and other data associated with the camera 300). For example, the IoT service enabler can store information about the connectivity of the camera 300 (e.g., a signal strength of the camera 300 with the telecommunications network) or any other information related to the camera 300 or its connection with the network.

The IoT service enabler can maintain the registration of the camera 300 in accordance with the lifetime of the registration communicated in the registration request. For example, the lifetime can indicate a period of time for which the registration is maintained without an additional registration update or reregistration. Thus, the IoT service enabler can de-register and cease management of the camera 300 in response to the expiration of the registration lifetime without an additional registration update or reregistration. Once the camera 300 is de-registered from the IoT service enabler, the camera 300 can reregister with the IoT service enabler using a similar process to that described above. Alternatively, to maintain the registration of the camera 300, the camera 300 (e.g., through the communication module 306) can transmit registration update communications (e.g., separate from or within other communications, such as communications providing sensor data) using the active data bearer and update the IoT service enabler with any changes in its status or configuration. In yet other aspects, the registration can be maintained until it is expressly de-registered with a subsequent communication.

Once the camera 300 is registered with the IoT service enabler, the camera 300 and the IoT service enabler can communicate to manage the camera 300. The IoT service enabler can receive data communicated by the camera 300 and perform various operations, such as storing, analyzing, or forwarding the data. For example, the IoT service enabler can store the data within resources of LwM2M objects registered to the IoT service enabler, forward the data to one or more other applications accessible by a user of the camera 300 to monitor the camera 300, or analyze the data to determine operations to manage the camera 300 or provide an indication of the status of the camera 300 to the one or more applications accessible by the user.

The camera 300 includes a device control module 308 that can control operation of the camera 300. In aspects, the device control module 308 is used to perform operations at the camera 300 based on signaling received from the IoT service enabler through the communication module 306. For example, the communication module 306 can receive commands from the IoT service enabler to lock or unlock the device to disable one or more functionalities of the device. In aspects, the commands can be communicated using resources of LwM2M objects. For example, an LwM2M device object (Object ID: 3) can be used to control operation of the IoT device 200. The communication module 206 can receive commands associated with a resource defined in the LwM2M device object or any other LwM2M object to lock or unlock the IoT device 200.

The device control module 308 can similarly be used to switch from an IP data bearer to a non-IP data bearer, or vice versa, in response to signaling. For example, an APN connection profile LwM2M object (Object ID: 11) can be used to control the active data bearer on which the IoT device 300 communicates. Accordingly, the device control module 308 can include logic that can switch the IoT device 300 between communicating using the different data bearers. The communication module 306 can switch between the multiple data bearers by altering an LwM2M APN connection profile object indicating an active APN connection profile of the camera 300 to reflect the active data bearer (e.g., IP-based or non-IP-based) or activating communication components (e.g., software/modems) used to communicate on the active data bearer and deactivating communication components used to communicate on the inactive data bearer. In yet other aspects, the device control module 308 can alter one or more settings of the camera 300, such as brightness, exposure, aperture, a maximum storage size, burst length, audio settings, or any other camera setting. It yet other aspects, the device control module can install one or more firmware or software packages at the camera 300.

In general, the device control module 308 can receive read, write, or execute commands associated with a resource of an LwM2M object. A read command can cause the device control module 308 to retrieve the current value of a resource from an LwM2M object. When the IoT service enabler issues a read command, the camera 300 responds with the requested data. The read command can be used to monitor the status or configuration of the camera 300. The write command can cause the device control module 308 to update the value of a resource within an LwM2M object. Write operations can be used by the IoT service enabler to configure or control the camera 300 remotely. When a write command is issued, the device control module 308 can update the specified resource with the new value provided by the IoT service enabler. The execute command can be used to trigger a specific action or operation on the camera 300 by the device control module 308. Unlike read and write commands, which deal with data values, the execute command can initiate a predefined function or procedure on the camera 300. When the IoT service enabler issues an execute command, the device control module 308 can perform the corresponding action.

The camera 300 includes one or more sensors 310 used to collect data to provide functionality to the camera 300. For example, the sensors 310 can include imaging sensors used to collect image data or audio sensors used to collect audio data. The sensors 310 can further include any sensor that can collect data related to the camera 300. As a specific example, the sensors 310 can include a location sensor to collect location data of the camera 300. Moreover, the sensors 310 can include tamper sensors that can be used to determine if a device has been stolen or tampered with.

### Example IoT Service Snabler

FIG. 4 illustrates an example IoT service enabler 400 in which aspects of the present technology can be implemented. The IoT service enabler 400 can be hosted on a server of a provider of the wireless network. Thus, the IoT service enabler 400 can be a service provided to users who connect their cameras to the wireless network. In other cases, the IoT service enabler 400 can be a separate product implemented separately from the wireless network. In any event, the IoT service enabler 400 can be used to manage standalone digital cameras (e.g., standalone digital camera 412) and provide additional functionality over a wireless network. The IoT service enabler 400 can implement a DDI platform.

The IoT service enabler 400 includes at least one processor 402. The processor 402 can execute machine-readable instructions to manage and execute all computational tasks performed by the IoT service enabler 400. For example, the various modules of the IoT service enabler 400 can include machine-readable instructions executed by the processor 402. The processor 402 can be located at the IoT service enabler 400 or remotely coupled with the platform 400. In aspects, the processor 402 can be a central processor or an application-specific processor.

The IoT service enabler 400 includes a device management module 404 responsible for managing one or more devices managed by the IoT service enabler. The device control module 404 can register the devices with the IoT service enabler 400 (e.g., using the LwM2M protocol). Once registered, the device management module 404 can update the registration or de-register the device in response to one or more communications (or lack thereof). For example, in response to registration updates from a standalone digital camera 412, the device management module 408 can refresh the registration (e.g., restart the lifetime of the registration) of the camera 412. The device management module 408 can similarly update any aspects of the registration if the registration update indicates to do so. If no registration update is received in the lifetime of the registration, the device management module 408 can de-register the camera 412. In other cases, a registration can be maintained indefinitely until explicitly directed to de-register the camera 412.

Once registered, the device control module 404 can store data received from the camera 412 in relation to the registration of the camera 412 (e.g., in resources of LwM2M objects). The device control module 404 can further send and receive communications to/from the one or more managed devices. For example, the device control module 404 can receive sensor data collected by the camera 412 and communicated over the wireless network. The device control module 404 can provide data from the camera 412 to a data management module 408 for storage in relation to a registration of the camera 412 with the IoT service enabler 400. The device management module 404 can similarly communicate with the camera 412 to cause on or more on-device actions at the camera 412. For example, the device management module 404 can transmit communications to the camera 412 to remotely disable one or more functionality of the camera 412, cause the camera 412 to return data (e.g., collected by the camera 412), adjust one or more setting of the camera 412, cause the camera 412 to switch to a new data bearer, or cause the camera 412 to upload one or more images, cause the camera 412 to install one or more software/firmware packages, or cause the camera 412 to perform any other on-device action.

The IoT service enabler 400 includes a communication module 406 that can communicate with the camera 412 over the wireless network. For example, the communication module 406 can communicate the signaling from the device management module 404 that is used to control aspects of the camera 412. The communication module 406 can communicate using any communication protocol. For example, the communication module 406 can communicate with the camera 412 using CoAP (e.g., using the LwM2M protocol), the MQTT protocol, HTTP, or any other communication protocol. In aspects, the communication module 406 can receive and transmit commands within resources of LwM2M objects.

The data management module 408 can analyze data received from the camera 412 to determine which operations are needed to control the camera 412 or determine which notifications to provide to the applications 414. For example, the device management module 408 can store, in association with the camera 412 managed by the IoT service enabler 400, data about the camera 412 (e.g., location, images, settings, or other sensor data) or its connection to the network. In aspects, the IoT service enabler 400 can determine a signal strength between the network on which the camera 400 is communicating with the IoT service enabler 400 (e.g., from an LwM2M object associated with the device (Object ID: 4 or 5) and having a resource indicating the signal strength). Based on the signal strength, the data management module 408 can determine that the camera has inadequate network resources for a current data bearer (e.g., an IP-based data bearer) and indicate that the IoT device would benefit from a switch to a different data bearer (e.g., a non-IP data bearer).

The data management module 408 can similarly process location data and other device data to determine if a theft of the camera 412 has occurred. For example, the data management module 408 can store, in association with the camera 412 managed by the IoT service enabler 400, geofences in which the camera 400 is authorized to operate. The data management module 408 can compare location estimates received from the camera 412 to its geofence to determine whether the camera 400 is within or outside the geofence. If the camera 412 is outside of its associated geofence, the device management module 404 can issue a command (e.g., an execute command), through the communication module 406, to the camera 412 to lock the device. The commands can be communicated using resources of LwM2M objects, such as the LwM2M device object. Alternatively, a theft can be detected by analyzing device location information separate from any pre-identified authorized geofences (e.g., using a machine learning model). In this case, anomalous behavior can be associated with a possible theft. Alternatively or additionally, failed authentication or authorization of the user at the camera 412 or with the IoT service enabler 400 can trigger a determination that the camera 412 has been stolen or tampered with, resulting in a lock of the camera 412.

The data management module 408 can further store various data received from the camera 412. For example, the data management module 408 can store images from the camera 412 at the IoT service enabler 400 or at one or more applications 414 to provide managed backup or cloud storage of images recorded by the camera 412. These images can be restored to the camera 412 in the case of corruption or other deletion of data at the camera 412 or accessed remotely to limit the need for large amounts of on-device storage.

The user (or owner/manager) of the camera 412 can view information about the camera 412 and control operations of the camera through the IoT service enabler 400. For example, the IoT service enabler 400 includes a user interface module 410 that interfaces with the applications 414 that enable the user of the camera to control operation of their device and view data relating to their device. For example, the user interface module 410 can pass data and other information from the camera 412 (e.g., receive by the device management module 404 or processed by the data management module) to one or more applications 414 through representational state transfer (REST) APIs. Similarly, the user interface module 410 can receive communications from the applications 414 through the APIs.

In aspects, the user interface module 412 can present data received from the camera 412 to a user of the camera 412 (e.g., in a processed, digestible form) through APIs to enable the user to benefit from and manage their device. For example, the user can view sensor data, such as location data, tamper data, theft indications, software/firmware update notices, settings data, or any other camera data, collected by the camera 412 and communicated to the IoT service enabler 400. The user can similarly view images collected by the camera 412 through the applications 414. In this way, the IoT service enabler 400 can facilitate a cloud storage or backup of the camera 412 over the wireless telecommunications network.

Moreover, the user can issue commands through the API to cause the IoT service enabler 400 to initiate operations at the camera 412. For example, the user can issue commands for the IoT service enabler 400 to lock the camera 412 (e.g., to remotely disable one or more feature of the camera 412). This command could be issued by the user in response to an indication that the device had been stolen being provided to the applications 414. Similarly, the user can initiate one or more software/firmware updates through the applications 414 and the user interface module 410. The user can similarly initiate operations for the IoT service enabler 400 to adjust one or more camera settings or perform any other operations at the camera 412. In general, communications between the IoT service enabler 400 and the applications 414 can take place through the APIs accessible to the IoT service enabler 400.

### Example IP-Based Communication Architecture

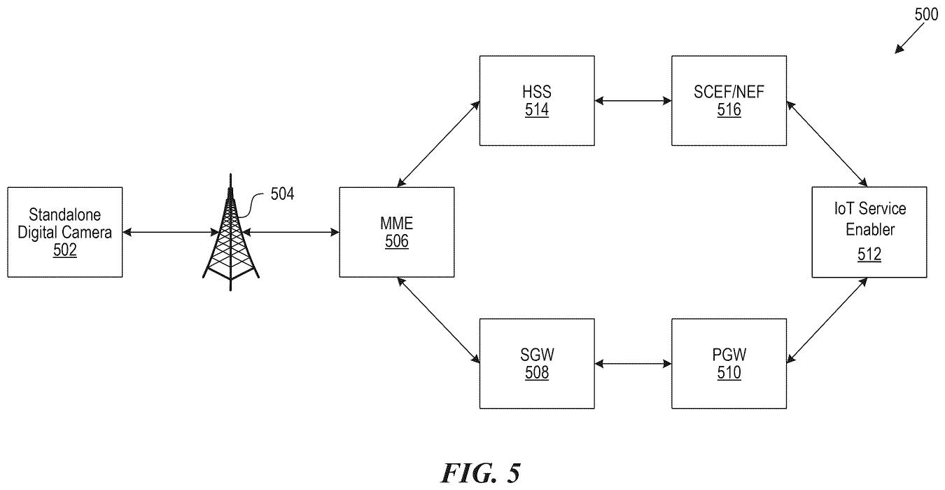

FIG. 5 illustrates an example architecture 500 for communication between a standalone digital camera 502 and an IoT service enabler 512 in accordance with aspects of the present technology. The data can be communicated across the user plane of the wireless telecommunications in compliance with any protocol of the IP suite, including the Transmission Control Protocol (TCP) or the User Datagram Protocol (UDP), and using an IP data bearer. Data can similarly be communicated between the standalone digital camera 502 and the IoT service enabler 512 through the control plane using a non-IP data bearer.

To enable communication between the standalone digital camera 502 and the IoT service enabler 512 on the telecommunications network, the digital camera 502 attaches to the telecommunications network. The digital camera 502 can attach to the network by communicating with a base station 504 (e.g., an eNB or gNB) providing network coverage to an area in which the camera 502 is located to enable access to the core network. Once the camera 502 is attached to the network through communication with a mobility management entity (MME 506), the camera 502 can be assigned an IP address (e.g., by the network's dynamic host configuration protocol (DHCP) server or through a static IP configuration) that can be used for subsequent IP-based communication. The communication can take place through an IP data bearer, which is a logical channel that carries IP packets between the IoT device 502 and the network. This IP data bearer can be established through one or more core network elements (e.g., a serving gateway (SGW 508) and a packet gateway (PGW 510) or UPF) of the telecommunication network. Given that the communication is IP-based, the communication can have specific QoS parameters. Thus, the IP-based communication can communicate data with a larger bandwidth, reduced latency, reduced packet loss, and so on, making it appropriate for some critical data transmission situations (e.g., real-time video monitoring, real-time signaling, or in situations with high data loads and sufficient network coverage).

Once the IP data bearer is established, data can be communicated between the camera 502 and IoT service enabler 512 through the IP data bearer. For example, the camera 502 can communicate data (e.g., sensor data or control signaling) as the payload through the IP data bearer. The payload is encapsulated in IP packets that include a header. These packets can be configured in accordance with various protocols, such as UDP or TCP. For example, the header can include fields that identify the source and destination of the packet, indicate the packet size or configuration (e.g., window size), include security information, or include other information used for data transmission, reliability, and flow control. In some cases, the IP packets are encrypted (e.g., using protocols such as TLS or DTLS). Once packetized, the IP packets can be transmitted over the user plane of the telecommunications network using the IP data bearer.

Data can similarly be communicated using NIDD. NIDD enables data to be communicated without traditional IP-based protocols. NIDD utilizes an HSS 514 and a SCEF/NEF 516 to communicate data between the camera 502 and the IoT service enabler 512. In doing so, a payload can be communicated through the control plane of the telecommunications network without using traditional IP-based protocols. The payload can be transmitted without headers required for IP-based communication, thereby reducing the bandwidth required by NIDD in comparison to IP-based communication. Accordingly, NIDD can be provided at a lower cost compared to IP-based communication. Moreover, NIDD can be used to provide reliable communication even during high congestion events or when limited network coverage is available, avoid certain IP-based attacks, such as DDoS attacks, and reduce the utilization of limited IP addresses (e.g., particularly in IPv4 applications).

The SCEF/NEF 516 can facilitate communication between the camera 502 and the IoT service enabler 512 through the control plane. A non-IP data bearer can be established that uses the SCEF/NEF 516 instead of the PGW 510 or UPF, as in IP-based communication. The SCEF/NEF 516 can include a representational state transfer (REST) application program interface (API) that can reach interfaces within the IoT service enabler 512 to communicate data between the camera 502 and the IoT service enabler 512. The IoT service enabler 512 can include a SCEF/NEF connector that can connect with the SCEF/NEF 516 to receive or transmit data. For example, the SCEF/NEF 516 can deliver the payload through the REST API to the SCEF/NEF connector.

Once the non-IP data bearer is set up to communicate data on the control plane of the telecommunications network using the SCEF/NEF 516, the camera 502 and IoT service enabler 512 can communicate with one another on the non-IP data bearer. For example, the camera 502 can issue a registration request to register the camera 502 with the IoT service enabler 512 using the non-IP data bearer (e.g., through the SCEF/NEF 516). The IoT service enabler 512 can then register the camera 502 with the IoT service enabler so that subsequent communications, such as registration refresh messages, sensor data, and control data, can be transmitted through the non-IP data bearer while the registration is maintained.

### Communication Between the IoT Service Enabler and the Standalone Digital Camera

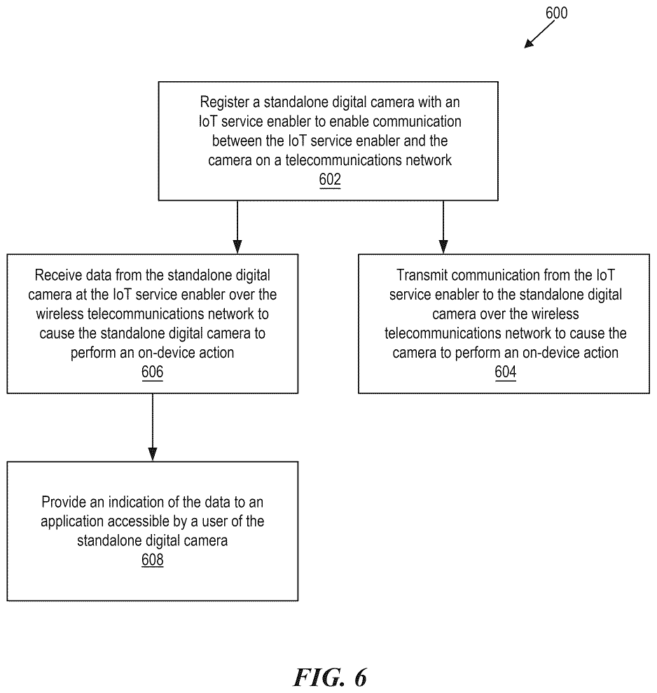

FIG. 6 illustrates an example method 600 for communication between a standalone digital camera and an IoT service enabler in accordance with aspects of the present technology. Although illustrated in a particular configuration, one or more operations of the method 600 may be omitted, repeated, or reorganized. Additionally, the method 600 may include other operations not illustrated in FIG. 6—for example, operations detailed in one or more other methods described herein. In aspects, the operations are performed by an IoT service enabler responsible for managing operations of one or more standalone digital cameras.

At 602, a standalone digital camera is registered with the IoT service enabler to enable subsequent communication between the IoT service enabler and the camera on a wireless telecommunications network. The camera can register with the IoT service enabler by transmitting a registration request. If the camera is authorized to register with the IoT service enabler, the request can be granted and the IoT service enabler can register the camera such that it is managed by the IoT service enabler. This management can include receiving data (e.g., control data or sensor data) from the camera, transmitting data to the camera, or causing one or more operations at the camera. Communication between the camera and the IoT service enabler can take place in accordance with the CoAP (e.g., the LwM2M protocol), the MQTT protocol, or the HTTP. In some cases, data and other communications can take the form of resources within LwM2M objects defined for the camera.

At 604, a communication from the IoT service enabler is transmitted to the standalone digital camera over the wireless telecommunications network to cause the standalone digital camera to perform an on-device action. The communication can be associated with the IMSI provisioned to the camera to enable subsequent communications on the wireless telecommunications network. The IoT service enabler can cause the camera to perform a software/firmware update, adjust a setting of the camera, return one or more data collected by the camera, disable one or more functionalities of the camera, or perform any other action. The communication can be initiated by a user through one or more applications connected to the IoT service enabler through one or more APIs accessible to the IoT service enabler. In other cases, the communication can be initiated from the IoT service enabler without approval from the user of the camera. In yet other aspects, the communication can be initiated by the IoT service enabler but is sent only after it is approved by the user of the camera.

At 606, a communication from the standalone digital camera is received by the IoT service enabler over the wireless telecommunications network to cause the standalone digital camera to perform an on-device action. The communication can be associated with the IMSI provisioned to the camera to enable subsequent communications on the wireless telecommunications network. The communication can include data collected by the standalone digital camera. For example, the communication can include location data, settings data, usage data, or any other kind of device data. The device data can be analyzed to determine ways in which to control the device. In some cases, the communication can include images from the camera to be stored at the IoT service enabler or at a cloud server. In this way, the IoT service enabler can facilitate backup or cloud storage of the images collected by the camera.

At 608, the data included in the communication from the standalone digital camera can be stored at the IoT service enabler. For example, the IoT service enabler can store the data in accordance with one or more LwM2M object resources. The data can be analyzed at the IoT service enabler, to determine a status of the camera. For example, location and other data can be analyzed to determine if the camera has been stolen or tampered with. An indication of the data can similarly be provided, through one or more APIs, to an application accessible by the user of the camera. For example, an indication of the current device settings or an indication that the camera has been stolen can be provided to the user. In this way, the user can manage the camera and receive status information about the camera remotely through an application.

### Computer System

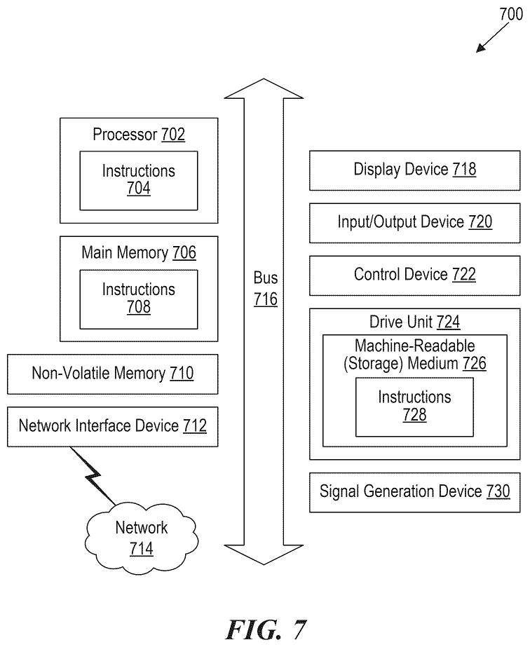

FIG. 7 is a block diagram that illustrates an example of a computing system 700 in which at least some operations described herein can be implemented. As shown, the computing system 700 can include one or more processors 702, main memory 706, non-volatile memory 710, a network interface device 712, a display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computing system 700 is intended to illustrate a hardware device on which components illustrated or described relative to the examples of the figures and any other components described in this specification can be implemented.

The computing system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR system (e.g., head-mounted display), or any electronic device capable of executing a set of instructions that specifies action(s) to be taken by the computing system 700. In some implementations, the computing system 700 can be an embedded computing system, a system-on-chip (SOC), a single-board computing (SBC) system, or a distributed system such as a mesh of computing systems, or it can include one or more cloud components in one or more networks. Where appropriate, one or more computing systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable (storage) medium 726) can be local, remote, or distributed. Although shown as a single medium, the machine-readable (storage) medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computing system 700. The machine-readable (storage) medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A method comprising:
registering, with a domain name system (DNS), dynamic host configuration protocol (DHCP), and IP address management (IPAM) (DDI) platform, a standalone digital camera having an international mobile subscriber identity (IMSI) within an embedded subscriber identity module (eSIM) of the standalone digital camera to enable subsequent communications between the IoT service enabler and the standalone digital camera on a wireless telecommunications network; and
after registering the standalone digital camera with the IoT service enabler:
transmitting, from the IoT service enabler, to the standalone digital camera, and over the wireless telecommunications network, a first communication comprising signaling causing the standalone digital camera to perform an action at the standalone digital camera,
wherein the first communication is associated with the IMSI;
receiving, at the IoT service enabler, from the standalone digital camera, and over the wireless telecommunications network, a second communication comprising data from the standalone digital camera,
wherein the second communication is associated with the IMSI; and
in response to receiving the second communication, storing the data from the standalone digital camera at the IoT service enabler.

2. The method of claim 1, further comprising provisioning, by the IoT service enabler, the IMSI to the standalone digital camera over the wireless telecommunications network.

3. The method of claim 1, wherein:
the first communication comprises a firmware or software over the air update; and
the signaling causes the firmware or software over the air update to be installed on the standalone digital camera.

4. The method of claim 1, wherein the signaling causes the standalone digital camera to perform an action using a lightweight machine-to-machine (LwM2M) protocol resource of the standalone digital camera.

5. The method of claim 1, wherein:
a first one of the first communication and the second communication is communicated using an internet protocol (IP) data bearer; and
a second one of the first communication and the second communication is communicated using a non-IP data bearer.

6. The method of claim 1, wherein the first communication or the second communication is communicated using a constrained application protocol (CoAP) or a message query telemetry transport (MQTT) protocol.

7. The method of claim 1, further comprising:
receiving, at the IoT service enabler, through an application programming interface (API), and from an application through which a user of the standalone digital camera can control a setting or operation of the standalone digital camera, a command to adjust the setting of the standalone digital camera or perform the operation at the standalone digital camera; and
in response to receiving the command, transmitting, the first communication comprising the signaling to cause the standalone digital camera to adjust the setting of the standalone digital camera or perform the operation at the standalone digital camera.

8. The method of claim 1, further comprising, in response to receiving the second communication, providing, to an application accessible by a user of the standalone digital camera and through an application programming interface (API), an indication of the data included in the second communication.

9. The method of claim 1, wherein the data included in the second communication comprises one or more images captured by the standalone digital camera.

10. The method of claim 1, wherein:
the data included in the second communication comprises location data;
the method further comprises determining that the standalone digital camera has been stolen or tampered with; and
in response to determining that the standalone digital camera has been stolen or tampered with, transmitting the first communication to remotely disable one or more function of the standalone digital camera.

11. The method of claim 1, wherein the data included in the second communication comprises one or more settings of the standalone digital camera.

12. A domain name system (DNS), dynamic host configuration protocol (DHCP), and IP address management (IPAM) (DDI) platform, comprising:
at least one processor; and
at least one non-transitory, computer-readable storage medium storing instructions that, when executed by the at least one processor, cause the at least one processor to:
register a standalone digital camera having an international mobile subscriber identity (IMSI) within an embedded subscriber identity module (eSIM) of the standalone digital camera to enable subsequent communications between the IoT service enabler and the standalone digital camera on a wireless telecommunications network; and
after registering the standalone digital camera with the IoT service enabler, transmit, to the standalone digital camera and over the wireless telecommunications network, a communication comprising signaling that causes the standalone digital camera to perform an action at the standalone digital camera,
wherein the communication is associated with the IMSI.

13. The IoT service enabler of claim 12, wherein the processor is further caused to provision, by the IoT service enabler, the IMSI to the standalone digital camera over the air.

14. The IoT service enabler of claim 12, wherein:
the first communication comprises a firmware or software over the air update; and
the signaling causes the firmware or software over the air update to be installed on the standalone digital camera.

15. The IoT service enabler of claim 12, wherein the signaling causes the standalone digital camera to perform an action using a lightweight machine-to-machine (LwM2M) protocol resource of the standalone digital camera.

16. The IoT service enabler of claim 12, wherein the IoT service enabler is communicatively coupled with the standalone digital camera using an internet protocol (IP) data bearer and a non-IP data bearer.

17. The IoT service enabler of claim 12, wherein the IoT service enabler is communicatively coupled with the standalone digital camera through an interface supporting a constrained application protocol (CoAP) and an interface supporting a message query telemetry transport (MQTT) protocol.

18. A domain name system (DNS), dynamic host configuration protocol (DHCP), and IP address management (IPAM) (DDI) platform, comprising:
at least one application programming interface (API) coupling the IoT service enabler to an application accessible by a user of a standalone digital camera;
at least one processor; and
at least one non-transitory, computer-readable storage medium storing instructions that, when executed by the at least one processor, cause the at least one processor to:
register a standalone digital camera having an international mobile subscriber identity (IMSI) within an embedded subscriber identity module (eSIM) of the standalone digital camera to enable subsequent communications between the IoT service enabler and the standalone digital camera on a wireless telecommunications network; and
receive from the standalone digital camera and over the wireless telecommunications, a communication comprising data from the standalone digital camera,
wherein the communication is associated with the IMSI; and
in response to receiving the communication, provide, through the API, an indication of the data to the application accessible by the user of the standalone digital camera.

19. The IoT service enabler of claim 18, wherein the data included in the second communication comprises one or more images captured by the standalone digital camera.

20. The IoT service enabler of claim 18, wherein the data included in the data comprises one or more settings of the standalone digital camera.
